(19) United States
(12) Patent Application Publication
(10) Pub. No.: US 2004/0232185 A1
(43) Pub. Date: Nov. 25, 2004

(54) Receiver hitch held ramp support

(76) Inventor: Kenneth S. Darby, Falls, PA (US)

Correspondence Address: Kenneth S. Darby, RR 1 Box 311, Falls, PA, 18615, US

(21) Appl. No.: 10/442,836

(22) Filed: May 20, 2003

(51) Int. Cl. B60R 9/00; B60R 11/00

(52) U.S. Cl. 224/521

(57) ABSTRACT

A device that inserts into a class III receiver hitch to support the upper end of a ramp which reaches to the ground and provides a means to load an ATV, golf cart, tractor, or motorcycle onto a pickup truck bed safely without the total weight being on the tailgate.

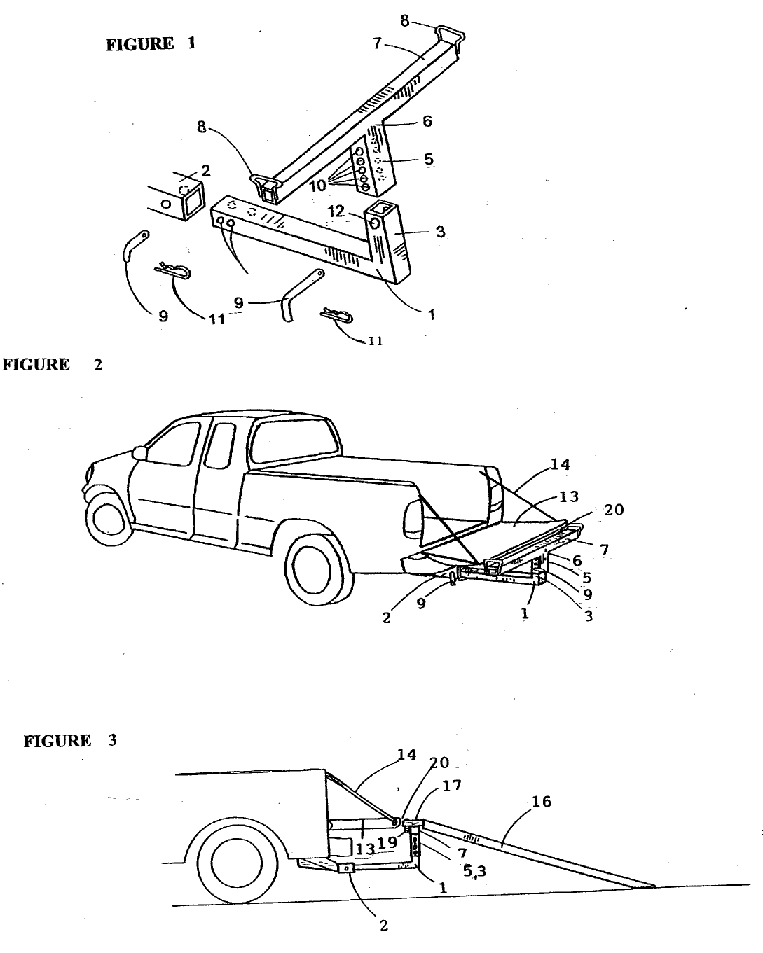

### FIELD OF INVENTION

With the increased popularity of ATV's and motorcycles, many riders of these off-road vehicles transport them in the back of their pick-up truck. To load ATV's and unload them, ramps are used that rest on the tailgate of the pick-up truck.

### BACKGROUND OF THE INVENTION

Tailgates on a pick-up are not designed to support the ramps with the weight of an ATV, lawn tractor, golf cart and a driver. The cables that hold up the tailgate lose strength as they age and rust. Often, the metal ramps scratch, dent, or bend the tailgate in the area where the ramps rest.

### OBJECTS OF THE INVENTION

This present invention is a two-piece load support with a “T” section and an “L” section that is inserted into a 2″ receiver hitch and extends and rises behind the lowered tailgate. The “T” section telescopes with the upper end of the “L” section, to adjust the height equal to the tailgate (bed height), or an inch or two below the tailgate surface. This provides a horizontal bar to support the ramps for loading a vehicle onto the truck. The small space between the support bar and the tailgate is easily spanned as the rubber tires roll across.

This invention is much like the mechanical design of Darby U.S. Pat. No. 5,950,890, Young U.S. Pat. No. 5,458,389, but this use is unobvious because these patents were designed for long items that lay on the truck bed that need support far beyond the tailgate. Ideally, this invention is only an inch or two beyond and an inch or two below the tailgate to support a ramp reaching from this device to the ground so as to allow the tire to easily roll from the top of the ramp onto the tailgate and then to the bed of the truck.

Another advantage of this present invention is that the ramp support bar is an inch or two below the tailgate, which results in less incline on the ramp, and is therefore easier and safer to use.

### SUMMARY

This invention is used when loading an ATV, golf cart, tractor or motorcycle onto a pickup truck. This invention supports the upper end of a ramp while the other end of the ramp is on the ground. The use of this ramp support is safer than placing the ramp onto the tailgate because there is enough space between it and the lowered tailgate for a protruding bracket to keep the ramp from moving forward or backward. Also, this ramp support takes the total weight from being exerted onto the tailgate, which in turn, may break the tailgate support cables.

### BRIEF DESCRIPTION OF THE DRAWINGS

Dwg. 1: Isometric view of the Hitch-Held Ramp Support.

Dwg. 2: Isometric view of the Hitch-Held Ramp Support in place.

Dwg. 3: Side view of the ramp resting on the Hitch-Held Ramp Support with a protruding pin.

### REFERENCE TO NUMERALS IN THE DRAWING

1. “L” section

2. Insertion Hitch

3. Vertical Leg

4. Horizontal Adjustment Hole

5. Telescoping Adjustment Area

6. Support Bar Lower Leg

7. Ramp Support Bar

8. Side Cleats

9. Keeper Pin

10. Height Adjustment Holes

11. Pin Keeper

12. Holes for Keeper Pin

13. Tail Gate

14. Tailgate Cables

15. Ramp

16. Ramp Top

17. Space Between Ramp/Support

18. Ground

19. Protruding Pin or Bolt

20. Space

### DETAILED DESCRIPTION OF THE DRAWINGS

FIG. I: Illustrates an exploded view with the “L” section (1) that will insert into the standard, truck-mounted insertion hitch (2) and pin (9) will pass through hole in the hitch and the hole (4) of the “L” (1). Keeper pin (11) will hold it securely in place. The lower part (5) of the “T” (6) telescopes with the upper part of the “L” (3) to adjust the ramp support bar (7) to a height of about one inch below the tailgate (13) surface and a pin (9) with keeper pin (11) will securely maintain the height. The support bar (7) has a side cleat (8) on each side to prevent ramp top (17) from sliding off sideways.

FIG. II: Illustrates the ramp support (7) with the horizontal leg of the “L” (1) inserted into the hitch (2) and held in place with pin (9). The tailgate (13) is lowered and held at bed level by cables (14). The support bar (7) is adjusted to about one inch below the tailgate (13) by telescoping the adjustment area of the lower “T” (5) with the vertical leg (3) and kept in place with a pin (9) and a keeper pin (11). The distance between the tailgate (13) and the ramp support bar (7) should be over one inch of space (20) and can be adjusted horizontally by replacing the pin (9) through the hitch (2) and through the proper hole (4) in the horizontal leg of the “L” section (1).

FIG. III: Illustrates a side view of a ramp top (17) resting on the ramp support bar (7) and the far end of the ramp (16) on the ground (18). The ramp support (7) is held in place by pin (9) through the adjustment section of the “T” (5) and the “L” (3) while the horizontal section of the “L” (1) with holes (4) are inserted and pinned to the insertion hitch (2). The ramp top (17) that rests on top support bar (7) can have a hole drilled about 3″ from incline end of ramp (16) for a bolt (19) to protrude into space (20) between the tailgate (13) and the ramp support bar (7).

What I claim is:

1. A device with a “T”-shaped support bar and an “L”-shaped extension, which inserts into the receiver hitch of a pickup truck and reaches up behind the lowered tailgate. This device has a horizontal adjustment by telescoping in and out of the insertion hitch and a vertical adjustment by telescoping the free end of the “L” with the lower end of the “T” to support ramps leading a vehicle from the ground up to the tailgate and truck bed. This device having a “T”-shaped ramp support bar perpendicular to an “L”-shaped tube mounted into an insertion hitch with enough adjustment to locate ramps an inch or two behind and an inch or two below the tailgate of a pickup truck. This level of support reduces the angle of the ramp and provides a safer method than resting the ramps on the tailgate to load an ATV, golf cart, tractor, or motorcycle onto a pickup truck.
